(19) United States
(12) Patent Application Publication
(10) Pub. No.: US 2006/0005318 A1
(43) Pub. Date: Jan. 12, 2006

(54) Washer control method and washer using the same

(75) Inventor: Jong Sun Yoon, Jinju-si (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/033,620

(22) Filed: Jan. 13, 2005

(30) Foreign Application Priority Data
Jul. 8, 2004 (KR) P2004-52838

(51) Int. Cl. B08B 3/12

(52) U.S. Cl. 8/158; 68/12.19; 68/12.21; 68/12.03; 68/12.05

(57) ABSTRACT

An apparatus and method for controlling water supply in a washer, having a tub connected to a cold water source, a hot water source, a water level detector, a water temperature sensor, and a heater, uses a multi-step water supply technique to reduce energy consumption while maintaining washing effectiveness. The method includes selecting a wash course to set a predetermined water temperature; detecting a laundry amount to set a predetermined water level; first supplying the tub with an amount of water from the cold water source and the hot water source to reach a predetermined intermediate temperature for dissolving detergent in the amount of water; second supplying, after the first supplying, the tub with water from the hot water source to reach the predetermined water level as measured by the water level detector; driving, after the second supplying, the heater to heat the water in the tub to the predetermined water temperature as measured by the water temperature sensor; and executing the selected wash course

This application claims the benefit of Korean Application No. 10-2004-0052838 filed on Jul. 8, 2004, which is hereby incorporated by reference.

### BACKGROUND OF THE INVENTION

1. Field of the Invention

The present invention relates to a fully automatic washer, and more particularly, to an apparatus and method for controlling the supply of water to such a washer using a multi-step water supply technique and by selectively driving a heater.

2. Discussion of the Related Art

A fully automatic washer is an apparatus for washing laundry by executing a series of steps according to a predetermined program or wash course, which typically includes wash course cycles of water supply, washing, rinsing, and dewatering. Here, it should be noted that the water is generally supplied to a tub directly from a service pipe at a temperature too low to dissolve a detergent adequately for washing, and the low temperature water also diminishes washer performance. In cold weather conditions, the temperature of water from a service pipe may be very low.

As an alternative, the washer may be connected to a hot water tap connected to an external device such as a home water heater, which consumes a great deal of energy to heat large amounts of water indiscriminately and to transport the heated water to a specific site for use at a specific time. The operation of such a device is particularly inefficient when only small amounts of heated water are needed for short periods of time, but efficiency may be improved by providing a heater to a washer, as disclosed in Korean Patent Application Laid-open No. 10-2003-0055973 (filed by the present applicant). Such a washer, however, still consumes energy excessively since the heater is driven indiscriminately, from the initial supply of water, to heat the water to a temperature set according to a user-selected course.

### SUMMARY OF THE INVENTION

Accordingly, the present invention is directed to a washer control method and washer using the same that substantially obviate one or more of the problems due to limitations and disadvantages of the related art.

An object of the present invention, which has been devised to solve the foregoing problem, lies in providing a method for controlling a water supply in a washer having a tub connected to a cold water source, a hot water source, a water level detector, a water temperature sensor, and a heater, which reduces energy consumption by performing a multi-step water supply.

Another object of the present invention is to provide a method for controlling a water supply in a washer having a tub connected to a cold water source, a hot water source, a water level detector, a water temperature sensor, and a heater, which maintains washing effectiveness by achieving a sufficient water temperature for dissolving detergent.

Another object of the present invention is to provide a method for controlling a water supply in a washer having a tub connected to a cold water source, a hot water source, a water level detector, a water temperature sensor, and a heater, which enables a selective control of the heater for maintaining a predetermined water temperature using a minimum of heater current.

Another object of the present invention is to provide a washer suitable for performing any of the above methods.

Additional features and advantages of the invention will be set forth in the description which follows, and in part will be apparent to those having ordinary skill in the art upon examination of the following or may be learned from a practice of the invention. The objectives and other advantages of the invention will be realized and attained by the subject matter particularly pointed out in the specification and claims hereof as well as in the appended drawings.

To achieve these objects and other advantages in accordance with the present invention, as embodied and broadly described herein, there is provided a method for controlling a water supply in a washer having a tub connected to a cold water source, a hot water source, a water level detector, a water temperature sensor, and a heater. The method comprises selecting a wash course to set a predetermined water temperature; detecting a laundry amount to set a predetermined water level; first supplying the tub with an amount of water from the cold water source and the hot water source to reach a predetermined intermediate temperature for dissolving detergent in the amount of water; second supplying, after the first supplying, the tub with water from the hot water source to reach the predetermined water level as measured by the water level detector; driving, after the second supplying, the heater to heat the water in the tub to the predetermined water temperature as measured by the water temperature sensor; and executing the selected wash course.

In another aspect of the present invention, there is provided a washer, comprising a tub connected to a cold water source, a hot water source, a water level detector, a water temperature sensor, and a heater; and a controller for outputting a set of control signals for first supplying the tub with an amount of water from the cold water source and the hot water source to reach a predetermined intermediate temperature for dissolving detergent in the amount of water, for second supplying, after the first supplying, the tub with water from the hot water source to reach a predetermined water level as measured by the water level detector, and for driving, after the second supplying, the heater to heat the water in the tub to a predetermined water temperature as measured by the water temperature sensor.

It is to be understood that both the foregoing explanation and the following detailed description of the present invention are exemplary and illustrative and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram of a washer according to the present invention;

FIG. 2 is a diagram of a water supply process according to the present invention; and

FIG. 3 is a flowchart of a washer control method according to the present invention.

### DETAILED DESCRIPTION OF THE PREFERRED EMBODIMENT

Reference will now be made in detail to the preferred embodiment of the present invention, examples of which are illustrated in the accompanying drawings. Throughout the drawings, like elements are indicated using the same or similar reference designations where possible.

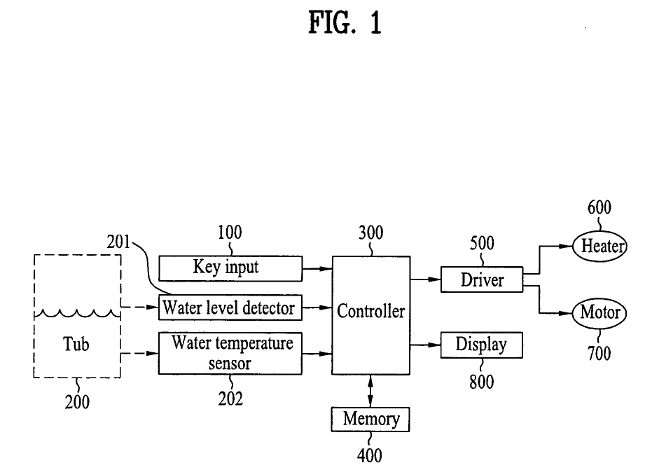

Referring to FIG. 1, a washer according to the present invention controls the supply of water to a tub 200 for accommodating laundry to be washed according to a selected wash course. The washer includes a key input 100 for inputting a user command to select a specific wash course and to initiate washer operation, a water level detector 201 for detecting a desired level of water in the tub 200, and a water temperature sensor 202 for sensing a desired temperature of the water in the tub, which is separately connected to a cold water source (not shown) and a hot water source (not shown). The desired water level varies according the amount of laundry in the tub 200, detected at the time of initiating washer operation, and the desired water temperature is set when selecting the wash course. A controller 300, which receives the output values of the water level detector 201 and the water temperature sensor 202 and stores reference values in a memory 400, executes each cycle of the selected wash course by controlling a heater 600 for heating the water in the tub 200 and a motor 700 coupled to the tub. A display 800 may be provided for displaying an operational state of the washer.

In the operation of the above-described washer, a wash course is selected and an operation command (e.g., start) is input via the key input 100, causing the controller 300 to output a set of control signals enabling the execution of the selected wash course, including control signals for performing a laundry amount detection to set up a water level, for controlling a desired supply of water to the tub 200 according to the detected laundry amount, and for controlling the temperature of the supplied water according to the selected wash course. The desired supply of water to the tub 200 is achieved by a multi-step water supply technique using a first water supply step followed by a second water supply step. In the first water supply, an intermediate water temperature, namely, a temperature (e.g., 32° C.) sufficiently high to dissolve completely a predetermined amount of detergent in the water, is achieved in the tub 200 by supplying both cold and hot water to the tub to a level below that corresponding to an amount of laundry. In the second water supply, a high water temperature, namely, a temperature corresponding to that of the hot water source, which is typically a temperature approaching or near the predetermined water temperature set according to the selected wash course, is achieved in the tub 200 by turning off the cold water and supplying only hot water to the tub until reaching the predetermined level set according the detected laundry amount. After reaching the predetermined water level by supplying only hot water, the water in the tub 200 is near the predetermined water temperature, and the heater 600 is selectively driven, as necessary, until the water temperature of the water in the tub reaches and maintains the predetermined water temperature. In the above two-step water supply technique, a detergent concentration is dissolved in a small amount of water for the first water supply, achieved using both cold and hot water as needed, but only the supply of hot water continues for the second water supply. Hence, the time for driving the heater 600 can be shortened to thereby reduce its energy consumption accordingly.

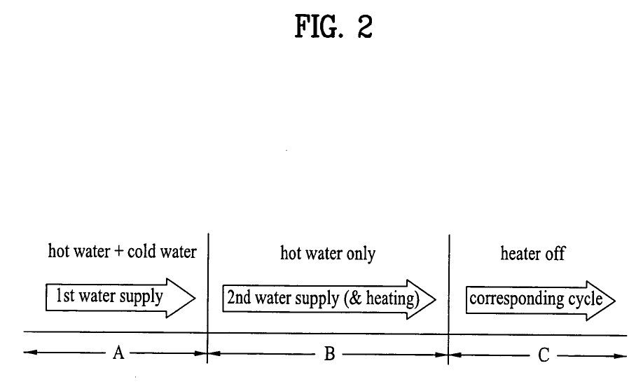

Referring to FIG. 2, a tub is supplied with cold water and hot water simultaneously, during a first water supply A, to achieve an intermediate temperature in the tub at a reduced water level. Here, the first water supply may be controlled according to the temperature of the hot water source, room ambient readings, measured water supply rates, etc. Thereafter, only the hot water is supplied during a second water supply B, i.e., the cold water supply is turned off, and the heater 600 is selectively driven according to a predetermined or desired water temperature. Once the desired water temperature is reached, the corresponding cycle C, e.g., a wash cycle or a rinse cycle, is carried out without driving the heater 600.

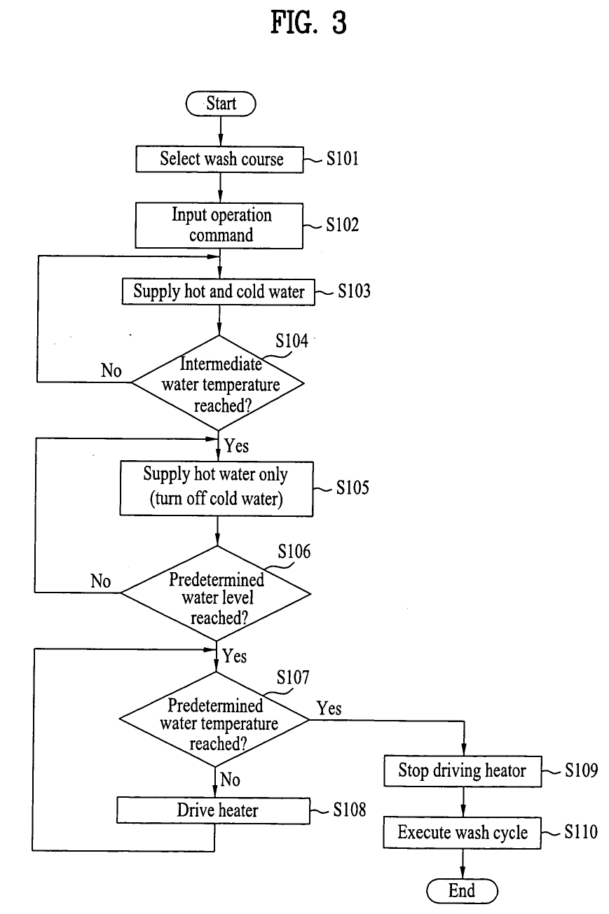

Referring to FIG. 3, illustrating a method for controlling a water supply in a washer according to the present invention, a wash course is selected (S101) using the key input 100, whereby water temperature values are set and stored based on a set of default values determined according to the selection, and the user inputs an operation command (S102) to execute a first water supply (S103) in which hot water and cold water are simultaneously supplied to a tub. As the hot and cold water supply proceeds, the controller 300 determines (S104) whether the output value from the water temperature sensor 202 reaches a first predetermined water temperature value stored in the memory 400. Once the water in the tub reaches the first predetermined temperature, a second water supply is executed (S105) in which the cold water supply is discontinued such that only the hot water is supplied. As the hot water supply proceeds, the controller determines (S106) whether the output value from the water level detector 201 reaches a predetermined water level value stored in the memory 400 according to the detected laundry amount. Once the water in the tub reaches the predetermined level, the controller 300 then determines (S107) whether the output value from the water temperature sensor 202 reaches a second predetermined water temperature value, which is stored in the memory 400 according to the selected wash course, while driving the heater 600 (S108). Thus, the heater 600 is driven only after supplying the water to the predetermined water level and only until the thus-supplied water reaches the second predetermined water temperature, whereupon the controller 300 stops driving the heater (S109) by controlling the driver 500 and thus cutting off a supply of current to the heater. Then, the controller 300 operates the motor 700 to execute the wash cycle (S110) according to the selected wash course. Here, the executed cycle may be a wash cycle or any one of a plurality of rinse cycles.

As described above, the user selects a wash course, a supply of water to a tub is performed to attain a predetermined water temperature set according to the selected wash course is carried out by the two-step water supply technique of the present invention, and a heater for heating the water in the tub is selectively driven according to the predetermined water temperature. By adopting the present invention, washing water is supplied to a tub using a multi-step water supply technique, applied according to the selected wash course executed by a fully automatic washer separately connected to each of a cold water source and a hot water source, to reduce energy consumption while maintaining washing effectiveness. The tub is initially supplied by a first water supply of a small amount of water at a temperature sufficient for dissolving detergent and is then supplied by a second water supply to a predetermined water level from the hot water source only, which can be supplied at a high temperature, i.e., near a predetermined water temperature set according to the selected wash course. In doing so, a heater can be selectively driven, as needed, to its reduce energy consumption accordingly, since the heater is needed only to heat the predetermined water level from the high temperature of the hot water source to the predetermined water temperature.

It will be apparent to those skilled in the art that various modifications and variations can be made in the present invention without departing from the spirit or scope of the invention. Thus, it is intended that the present invention cover such modifications and variations, provided they come within the scope of the appended claims and their equivalents.

What is claimed is:

1. A method for controlling a water supply in a washer having a tub connected to a cold water source, a hot water source, a water level detector, a water temperature sensor, and a heater, the method comprising:
selecting a wash course to set a predetermined water temperature;
detecting a laundry amount to set a predetermined water level;
first supplying the tub with an amount of water from the cold water source and the hot water source to reach a predetermined intermediate temperature for dissolving detergent in the amount of water;
second supplying, after said first supplying, the tub with water from the hot water source to reach the predetermined water level as measured by the water level detector;
driving, after said second supplying, the heater to heat the water in the tub to the predetermined water temperature as measured by the water temperature sensor; and
executing the selected wash course.

2. The method as claimed in claim 1, wherein the heater is not driven during said wash course execution.

3. The method as claimed in claim 1, wherein the heater is turned off when said second supplying is completed.

4. The method as claimed in claim 1, wherein the predetermined intermediate temperature is set according to the selected wash course.

5. The method as claimed in claim 1, wherein the water from the hot water source is supplied at a temperature higher than the predetermined intermediate temperature.

6. The method as claimed in claim 1, wherein the water from the hot water source is supplied at a temperature lower than the predetermined water temperature.

7. The method as claimed in claim 1, wherein the amount of water supplied by said first supplying is a lower level than the predetermined water level.

8. The method as claimed in claim 1, wherein the water from the cold water source is not supplied during said second supplying.

9. The method as claimed in claim 1, wherein the cold water source is turned off when than the predetermined intermediate temperature is reached.

10. A washer, comprising:
a tub connected to a cold water source, a hot water source, a water level detector, a water temperature sensor, and a heater; and
a controller for outputting a set of control signals for first supplying said tub with an amount of water from the cold water source and the hot water source to reach a predetermined intermediate temperature for dissolving detergent in the amount of water, for second supplying, after the first supplying, said tub with water from the hot water source to reach a predetermined water level as measured by the water level detector, and for driving, after the second supplying, the heater to heat the water in said tub to a predetermined water temperature as measured by the water temperature sensor.

11. A washer as claimed in claim 10, further comprising:
a key input unit for inputting a user command selecting a wash course to set the predetermined water temperature and for inputting an operation command to detect a laundry amount to set the predetermined water level.
